(19) United States
(12) Patent Application Publication
(10) Pub. No.: US 2019/0012666 A1
(43) Pub. Date: Jan. 10, 2019

(54) SYSTEMS AND METHODS FOR PROTECTING COMMUNICATIONS AND SUPPLY CHAIN INFORMATION

(71) Applicant: CABLE TELEVISION LABORATORIES, INC, LOUISVILLE, CO (US)

(72) Inventors: Simon Krauss, Denver, CO (US); Brionna Juarez Lopez, Broomfield, CO (US); Steven J. Goeringer, Westminster, CO (US); Brian A. Scriber, Denver, CO (US)

(21) Appl. No.: 16/133,593

(22) Filed: Sep. 17, 2018

Related U.S. Application Data
(63) Continuation-in-part of application No. 15/722,277, filed on Oct. 2, 2017.
(60) Provisional application No. 62/402,271, filed on Sep. 30, 2016.
(60) Provisional application No. 62/558,950, filed on Sep. 15, 2017.

(51) Int. Cl. G06Q 20/40

(52) U.S. Cl. CPC G06Q 20/401

(57) ABSTRACT

A system is provided for monitoring the status of a consumable good transferred from a first consumer to a second consumer. The system includes a first consumer device capable of acquiring an identifier from the consumable good, a storage subsystem configured to store one or more encrypted data files, an electronic network configured to transmit the acquired identifier from the first consumer device to the storage subsystem, and a second consumer device capable of acquiring the identifier from the consumable good and transmitting the acquired identifier to the storage subsystem. The storage subsystem is further configured to (i) store the acquired identifier from the first consumer device in a first encrypted data file (ii) store the acquired identifier from the second consumer device in a second encrypted data file, and (iii) delete or move the first encrypted data file upon creation of the second encrypted data file.

### CROSS REFERENCE TO RELATED APPLICATIONS

This application is a continuation-in-part of U.S. application Ser. No. 15/722,277, filed Oct. 2, 2017, which claims the benefit of and priority to U.S. Provisional Patent Application Ser. No. 62/402,271, filed Sep. 30, 2016. This application also claims the benefit of and priority to U.S. Provisional Patent Application Ser. No. 62/558,950, filed Sep. 15, 2017. The disclosures of all of these applications are incorporated by reference herein in their entireties.

### BACKGROUND

The field of the disclosure relates generally to tracking of materials and data, and more particularly, to systems and methods for protecting data and communications related to the supply chain for the materials.

Loss, misuse, and theft of materials and data is a critical problem in many industries. Furthermore, the details of how such material and data are used, and by which people, is important to know. This problem is more pronounced when the material and/or data are “consumable goods,” that is, materials or data products that are capable of being consumed, destroyed, dissipated, wasted, or spent. In one particular example, in the field of pharmaceutical materials, it may be very important, for insurance and safety reasons, to have information pertaining to the details of how opioids traverse a medical environment. Particular individuals may have a significant incentive to falsify records of how such materials, as well as associated data, are used in order to, for example, hide evidence of theft or other crimes, and/or acts of negligence or malpractice. Conventional methods, which rely on manual processes augmented by traditional databases, do not provide sufficient security transparency and visibility to attest confidently the disposition of critical materials as they traverse a system.

Accordingly, it is desirable to create a more secure system to track consumable goods through their limited life cycle, while also increasing security and transparency.

Additionally, in the case where the goods are conventional interactive devices, such as Internet-connected toys, baby monitors, etc., it has been very difficult to secure customer communications in the chain of supply, distribution, and use. Furthermore, Internet device providers often lose track of where the provided devices are post-sale, which renders it more difficult to inform consumers of important information about a sold device (e.g., recall notices), and which also limits the supply chain knowledge in general. This lack of supply chain knowledge also results in lost revenue opportunities for device manufacturers, who are unable to capture secondary market revenues that are sometimes available for goods such as interactive toys and games.

### BRIEF SUMMARY

In an aspect, a tracking system for monitoring the status of a consumable good using a distributed ledger is provided. The tracking system includes a receiver subsystem configured to submit to the distributed ledger a genesis transaction encoding details regarding an original consumable good, and a distributor subsystem configured to receive at least a distribution portion of the consumable good from the receiver subsystem and submit to the distributed ledger a first update transaction, based on the genesis transaction, encoding details regarding the receipt of the distribution portion by the distributor subsystem from the receiver subsystem.

In another aspect, a method of tracking the status of an original consumable good is provided. The method implements a digital distributed ledger having a plurality of participating processors over a distributed network. The method includes a step of generating a digitally signed genesis transaction to the plurality of participating processors for verification. The genesis transaction includes encoded information confirming an initiation of a life cycle of the original consumable good by a receiver. The step of generating further includes submitting the genesis transaction to the digital distributed ledger for verification. The method further includes a step of delivering, after verification of the digitally signed genesis transaction, a distribution portion of the original consumable good to a distributor, and generating a delivery transaction to the digital distributed ledger for verification. The delivery transaction includes encoded information confirming delivery of the distribution portion to the distributor. The method further includes a step of distributing, after verification of the delivery transaction, a consumption portion of the distribution portion to a consumer, and generating a distribution transaction to the digital distributed ledger for verification. The distribution transaction includes encoded information confirming receipt of the consumption portion by the consumer. The method further includes a step of recording, after verification of the distribution transaction, a consumption transaction including encoded information regarding a final disposition of the consumption portion.

In another aspect, a system is provided for monitoring the status of a consumable good transferred from a first consumer to a second consumer. The system includes a first consumer device capable of acquiring an identifier from the consumable good, a storage subsystem configured to store one or more encrypted data files, an electronic network configured to transmit the acquired identifier from the first consumer device to the storage subsystem, and a second consumer device capable of acquiring the identifier from the consumable good and transmitting the acquired identifier to the storage subsystem. The storage subsystem is further configured to (i) store the acquired identifier from the first consumer device in a first encrypted data file (ii) store the acquired identifier from the second consumer device in a second encrypted data file, and (iii) delete or move the first encrypted data file upon creation of the second encrypted data file.

### BRIEF DESCRIPTION OF THE DRAWINGS

These and other features, aspects, and advantages of the present disclosure will become better understood when the following detailed description is read with reference to the following accompanying drawings, in which like characters represent like parts throughout the drawings.

FIG. 1 is a schematic illustration of a tracking system that utilizes a digital ledger to securely monitor the status of consumables among various parties over a plurality of transactions, according to an embodiment.

FIG. 2 is a schematic flow illustration of a supply chain tracking process, according to an embodiment.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include any computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events occur substantially instantaneously.

The present systems and methods herein advantageously utilize distributed ledgers to confirm and/or record the status of consumable goods during their respective life cycle, from creation to consumption. The present embodiments may be implemented to augment or, in some circumstances, replace conventional tracking and security practices that rely on trusted parties to manually record events into databases or other record keeping mechanisms, such as trusted labels or tags, including bar codes, RFID tags, or other device identification methods. The distributed ledgers described and illustrated herein may include, for example, blockchain technology to create digital ledgers for tracking the status, location, and/or disposition of consumable goods. For ease of explanation, the following description references blockchains as an exemplary embodiment of distributed ledger technology. A person of ordinary skill in the art though, upon reading and comprehending the present description and associated illustrations, will understand that other examples of distributed ledger technologies may be implemented according to the novel and advantageous principles herein.

That is, in the following disclosure, the phrases “distributed ledger” and “blockchain” are used. In conventional practice literature, these two concepts are often considered to be synonymous. However, within this application, the two concepts may further differ in terms of their respective use and implementation. For example, in some instances the phrase “distributed ledger” may refer to how the ledger or blockchain is used, namely, the accessible distributed ledger as available to prove the facts of a transaction by virtue of being distributed amongst a consensus pool. A “blockchain,” on the other hand, may refer to the process by which the distributed ledger is created and operated. Accordingly, a blockchain will create a distributed ledger, but a distributed ledger may be created by other technologies as well. In the following description, the phrase “digital ledger” is utilized two referred to either or both of the distributed ledger and the blockchain.

The present solutions are thus advantageously implemented as either standalone systems, or as complementary systems to conventional recording systems that rely on trusted parties manually recording events into databases or other record keeping mechanisms, often using trusted labels. In such systems, it is important to track and verify information (e.g., specific times, location, duration, quantity, status etc.) of consumable goods move through/traverse a physical system or telecommunications network. The present embodiments are therefore of particular application to fields such as medical consumables (e.g., drugs and pharmaceuticals), law enforcement paraphernalia, contracts, and other fields where the consumable goods are often critical and/or of high value. In some embodiments, registration of the status of goods on the distributed ledger or blockchain may be implemented together with conventional identification and authentication processes, such as bar code scanning, RFID tagging, near field communications, biometrics, manual entries, etc.

According to the embodiments herein, digital ledgers are implemented to create secure and immutable records of transactions regarding the movement or status of consumable goods, or “consumables.” In these records, the transaction information is encoded into formats, digitally signed using a cryptographic technique, and submitted to a network of processors of a distributed ledger network. The processors validate the submitted transactions for accuracy, and the validated transactions are subsequently added to a queue or stack of the ledger. At some point, according to a predetermined criterion (such as, but not limited to, an interval of time, a volume of data, a number of transactions, or combination of these and other factors), the queued or stacked transactions are sequentially hashed (e.g., using a Merkle process), and collectively encoded into a block which is then hashed with the hash of the proceeding block using cryptographic processes. An algorithm will allow multiple processors to select a block from amongst many processors to be the block added to the blockchain.

In an exemplary embodiment, the distributed ledger is a blockchain. Blockchaining technology takes transaction information, encapsulates it in a digital envelope or “block” and then the block is cryptographically added (using cipher chaining techniques) to the end of a chain of other transactions. This cryptographic addition incorporates information from prior blocks on the chain to calculate the digital chain or “hash” for this new block. The calculations for cryptographic addition can vary widely in complexity based on the rules of the blockchain. This complexity is purposeful though, in order to prevent modification of the existing blockchain to which is being added. That is, in order to modify an earlier block in the chain, the entire chain from that point forward would need to be recalculated. It is through this technique that the immutability of the chain, and permanency of its public ledger, is maintained. Exemplary systems and methods of blockchain technology are described in greater detail in co-pending U.S. patent application Ser. No. 15/345,411, filed Nov. 7, 2016, U.S. patent application Ser. No. 15/376,375, filed Dec. 12, 2016, U.S. patent application Ser. No. 15/476,111, filed Mar. 31, 2017, and U.S. patent application Ser. No. 15/476,098, filed Mar. 31, 2017, all of which are incorporated by reference herein.

In the following embodiments, digital ledgers are utilized and/or created to track the status and movement of consumable goods. In an exemplary embodiment, the digital ledger is implemented to reliably record the status of one or more consumable from the time of reception from a manufacturer through a final state of consumption or disposal. According to the advantageous systems and methods described herein, the digital ledger may be utilized to automatically supplement, or substitute for, conventional practices that rely on trusted parties to manually record events into databases or other electronic record keeping mechanisms. In some embodiments, the present systems and methods utilize their own unique device technology to identify a person for association with one or more devices. In other embodiments, the present systems and methods may be implemented utilizing existing trusted identification technology, such as barcodes, RFID tags, biometric identifiers, etc.

The embodiments described herein are particularly useful for reliably associating critical devices with a particular person in the fields of medicine and law enforcement, smart contracts, and intellectual property (e.g., content-as-currency), for example. As described herein, details of transaction events (e.g., current status, changes in status) for a particular consumable good are encoded into a cryptographically signed and protected transaction that is submitted to a distributed ledger network, such as a blockchain network, for further processing. Processors of the distributed network process the incoming transactions into blocks, which may then be added to a particular blockchain. Once added to the blockchain (or equivalent entry in an electronic distributed ledger), the transaction is visible to, but immutable by, appropriate parties that seek to create a history of disposition and movement of critical goods for their respective life cycles. Such histories may then be more easily verified on the ledger, while being rendered more difficult to alter once added to the ledger. In some embodiments, the ledgers further track the association of persons to devices utilized in the system.

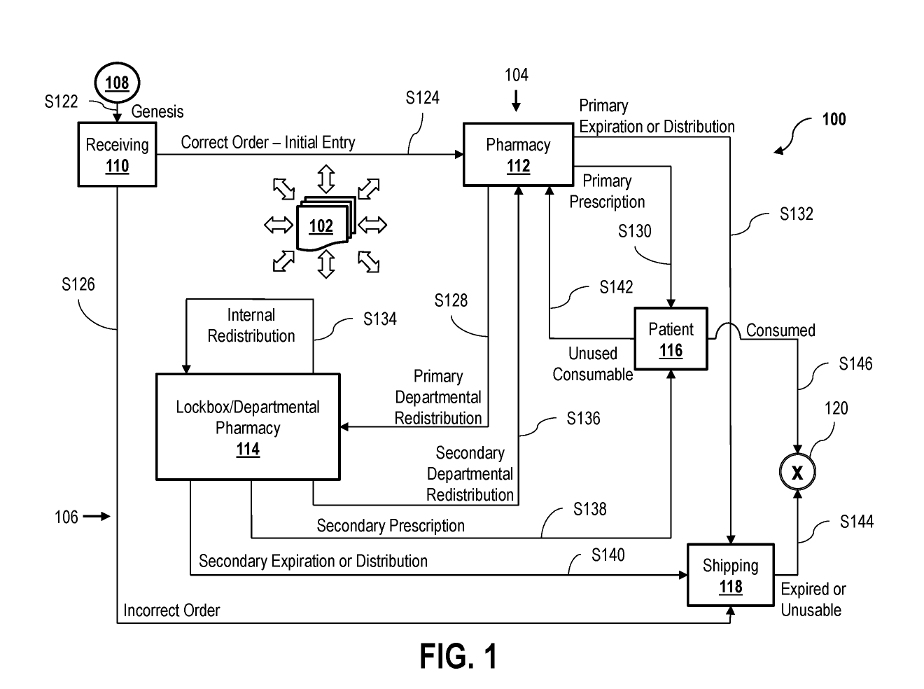

FIG. 1 is a schematic illustration of a tracking system 100 that utilizes a digital ledger 102 to securely monitor the status of consumables among various parties 104 as the consumables traverse system 100 over a plurality of transactions 106. System 100 is illustrated as an exemplary architecture to implement the distributed ledger embodiments of the present disclosure. Other architectures are contemplated by the present inventors, which do not depart from the scope of the embodiments. Furthermore, for ease of explanation, redundant components that may be implemented within system 100 are not illustrated, nor are link-level objects or implementations, security authentication objects/sequences/implementations, or other components that may be conventionally utilized in a distributed ledger network for communication, availability, or security purposes. In an exemplary embodiment of system 100, transaction events are communicated by nodes (not shown) respectively associated with one or more of parties 104, which are configured to communicate with processors (not separately shown) of digital ledger 102.

In the exemplary embodiment illustrated in FIG. 1, transactions, or steps, 106 are described relative to how the respective transaction 106 is submitted to, and recorded on, digital ledger 102. Individual process steps that may also be performed by parties 104, or persons and/or devices associated therewith are not shown. That is, system 100 is described herein primarily with respect to the interaction with digital ledger 102, and is not intended to describe all other potential processing steps for initiating, validating, and appending transactions to digital ledger 102 that may be performed by persons (e.g., manual entries) or other devices (e.g., data transmissions, communication protocols, etc.), as described above with respect to the co-pending patent applications incorporated by reference. For the purposes of this written description, the terms “material and data,” “consumable goods,” and “consumables” may be used interchangeably.

In some embodiments, digital ledger 102 utilizes a certificate authority (not shown) as a trusted entity in order to validate digital signatures against electronic documents and/or digital certificates issued by the certificate authority to verify the identity of one or more of parties 104 for each transaction 106. Such digital certificates may, for example, be implemented according to secure communication techniques such as a conventional public key infrastructure (PKI). In the exemplary embodiment, parties 104 include electronic communication means capable of wired or wireless electronic communication over the Internet.

The following exemplary implementation of system 100 is described with respect to medical consumables. Nevertheless, a person of ordinary skill in the art will understand, upon reading and comprehending the present application, how the principles of system 100 apply to other fields (e.g., law enforcement, smart contracts, etc.) where securely and transparently tracking the status and the physical or virtual movement of a consumable is valuable. Further in the exemplary embodiment, digital ledger 102 is a blockchain network, or a blockchain, and system 100 leverages digital signatures/hashes and/or Merkle roots/trees to reliably monitor and track the consumable status and movement using the blockchain.

In the exemplary embodiment of system 100 illustrated in FIG. 1, parties 104 include one or more of an originator 108, a receiver 110, a distributor 112, at least one storage facility 114, a consumer system 116, a shipping facility 118, and a resolution state 120. In this example, originator 108 is a pharmaceutical manufacturer, receiver 108 is a medical facility or pharmacy central office, distributor 112 is a dispensing pharmacy, consumer system 116 is a medical patient, and shipping facility 118 is an order processing unit or distribution center of originator/manufacturer 108 that is capable of shipping and receiving consumables. Although originator 108 and shipping facility 118 represent, in this example, the same manufacturer, two separate parties 104 are illustrated in FIG. 1 to emphasize the different roles of an original consumable order, as oppose to a returned consumable, and the different (albeit somewhat interrelated) transactions 106 respectively created therefrom.

In some embodiments of system 100, some or all of parties 104 are in direct or indirect operable communication with an electronic communications network (e.g., Internet, LAN, WAN, etc.). In at least one embodiment, one or more of parties 104 is further in operable communication with a certificate authority (not shown), where access to, or verification of, digital certificates is desired. That is, a certificate authority may be utilized to verify the digital identities of the respective parties 104 on the electronic communications network and issue a digital certificate to function as a trusted root certificate (e.g., embedded in hardware or software of the one or more parties 104) for transactions 106. In the exemplary embodiment, digital ledger 102 is a blockchain, and PKI-based certificates are utilized to implement secure communication between and authentication of parties 104 for each transaction 106.

In exemplary operation, each transaction is submitted to blockchain 102, verified by the processors of the blockchain (e.g., by a consensus model), and then recorded as new blocks onto the ledger of blockchain 102. In this example, each of parties 104 includes a party-specific identifier (ID) that may be digitally verified by the blockchain for each respective transaction 106. Patient 116, for example, may include a wearable coded wristband if a patient in a hospital, or alternatively, may carry a physical ID (e.g., a driver's license) that is capable of being scanned or recorded by pharmacy (distributor) 112 and then digitally verified by blockchain 102.

In exemplary operation, in step S122, originator 108 initiates a shipment of new consumables to receiver 110. Shipment step S122 generates a genesis transaction that digitally records details of the shipment, including without limitation, a manufacture ID, quantities, units of measure, perishability, recipient IDs, location, use restrictions, time, date, and physical location (alternatively, a virtual location in the case of data consumables) of both originator 108 and receiver 110. In the exemplary embodiment, the information of the recorded details is encoded into the genesis transaction, and the genesis transaction is digitally signed. The genesis transaction is subsequently submitted to the network of blockchain processors for validation and recording to blockchain 102.

The genesis transaction includes information and detail sufficient to authenticate and identify originator 108 and receiver 110, as well as particular characteristics specific to track shipment step S122, and thus enables subsequent transition steps between parties 104 to be similarly submitted to, verified by (e.g., validating the digital signature), and recorded on blockchain 102 as the associated consumable traverses system 100. In an exemplary embodiment, one or both of originator 108 and receiver 110 is notified if the genesis transaction is not validated. In at least one example, the shipment does not leave originator 108 if the genesis transaction is not validated, or alternatively, if the shipment has been sent, the notification allows receiver 110 to refuse delivery. In step S122, upon validation of the genesis transaction, receiver 110 accepts shipment, and the delivery acceptance is submitted to, validated by, and recorded on blockchain 102.

In some embodiments, the genesis transaction is created by receiver 110 upon receipt of the consumable, and includes only encoded details regarding originator 108, but the ID of receiver 110 may be used as both the sender and recipient ID of the genesis transaction. In one example, where receiver 110 is a hospital, the genesis transaction may be created upon a re-start or re-certification date of a piece of medical equipment that is appropriately re-used or recycled (e.g., a dialysis machine after overhaul and sterilization procedures are fully implemented). In this example, the use of the medical equipment is the consumable good (i.e., the digital data recording the life cycle of the equipment use), and the genesis transaction is generated upon the start of each new original use/re-use, or the re-use of the equipment may create its own update transaction event, reflecting the relevant subsequent date and other usage details, that is based on the genesis transaction for the life cycle of the equipment used in system 100.

Upon receipt of the consumables, a determination is made by receiver 110 (assuming validation of the genesis transaction) whether the consumables shipment was shipped correctly in step S122 (e.g., correct product, quantities, etc.). If the determination is made that the received shipment is correct, receiver initiates step S124, in which an initial entry transaction is generated and submitted to blockchain 102, along with relevant details of the received consumable(s), which are encoded into the initial entry transaction and recorded on the ledger, and then the original shipment is delivered to distributor 112. In some instances, the entirety of the original shipment may not sent to a single distributor, and instead split among a plurality of distributors 112. Under such circumstances, in step S124, receiver 110 will generate a plurality of initial entry transactions from the single genesis transaction, with each initial entry transaction respectively encoded with a different recipient ID of the respective distributor 112, as well as other different details of the sub-shipment that are relevant to that particular portion of the consumables. Each of the plurality of initial entry transactions may then be separately submitted to, validated by, and added to the ledger of block chain 102.

Referring back to step S122, if receiver 110 instead determines that that the original shipment was not shipped correctly, receiver 110 initiates step S126, in which the shipment of consumables is returned to shipping facility 118. In this example, step S126 further generates an incorrect order transaction, in which will be encoded the respective IDs of recipient receiver 110 and shipping facility 118 (e.g., a shipping manager of originator 108), and shipping facility 118 will initiate a distribution transaction, including details of receipt of the return delivery, as well as discrepancies between an original order and the original shipment received in step S122, and submit the distribution transaction to the block chain for validation and recording. In this example, the distribution transaction may update original data in the genesis transaction by appending corrected details in a subsequent block on a block chain 110. That is, the original genesis block of the genesis transaction will remain immutable, but subsequent blocks, added from the distribution transaction, will indicate the modification to the genesis transaction.

Referring back to the receipt of consumables by pharmacy 112 in step S124, upon validation of receipt according to the initial entry transaction, pharmacy 112 makes a determination that the received consumables are: (i) subject to immediate storage by storage facility 114; (ii) designated for immediate consumption by patient 116; or (iii) expired, or otherwise unusable. Details of this determination are encoded into one of the following transactions, which is initiated based on the result of the determination. In some embodiments, originator 108 may ship a consumable directly to pharmacy 112, and receiver 110 does not physically receive the consumable. In this example, receiver functions to generate the genesis transaction and the initial entry transaction. Receiver 110 may thus, in some instance, represent a processor of pharmacy/distributor 112.

If pharmacy 112 determines that the received consumables (or a portion thereof) are subject to immediate storage, system 100 initiates step S128, in which a primary departmental redistribution transaction is generated, and the received consumables are delivered to storage facility 114. In some embodiments, storage facility 114 is a plurality of storage facilities, and the consumables delivered in step S128 are split evenly or unevenly among one or more of the plurality of storage facilities 114. In such instances, a plurality of respective primary departmental redistribution transactions are initiated for each separate delivery, with each respective primary departmental redistribution transaction encoding therein the pharmacy/distributor ID, the respective recipient storage facility ID, and other details of the transaction relevant to the specific delivery of the portion of consumables to the particular storage facility 114. In at least one embodiment, step S128 further encodes, within the one or more primary departmental redistribution transactions, details regarding any division of the quantity of consumables received by pharmacy 112 into the respective sub-portions sent to the one or more storage facilities 114. All of these details are submitted to blockchain 102 as either a single transaction, or as multiple sub-transactions, for validation and addition to the ledger.

Alternatively, if pharmacy 112 determines that the received consumables (or a portion thereof) are designated for immediate consumption, system 100 initiates step S130, in which a primary prescription transaction is generated, and all or some of the consumables received by pharmacy 112 are delivered to consumer/patient 116. In step S130, prescription transaction encodes details of the pharmacy ID, the patient ID (e.g., hospital wristband, driver's license, etc., which is typically verified by pharmacy 112) and other relevant details of the delivery, including without limitation, time, date, location of delivery, insurance payment information, patient payment information, and refill information. All such details are then submitted to blockchain 102 as a single transaction or multiple sub-transactions for validation and addition to the ledger.

In some instances of step S130, the quantity of consumables received by pharmacy 112 is designated for immediate consumption by a plurality of patients 116 in equal or unequal quantities. In such circumstances, a plurality of primary prescription transactions are generated by pharmacy 112 for each respective prescription delivery to a different patient 116, similar to the subprocess described above with respect to the plurality of storage facilities 114. That is, each respective primary prescription transaction may be separately encoded with the relevant details particular to that primary prescription transaction (e.g., patient ID, quantity, and other details are likely to vary) and submitted to blockchain 102 for validation and entry based on the same genesis transaction and initial entry transaction.

Referring back to the determination made by pharmacy 112 after validation of step S124, in some instances, the determination is made that all or some of the received consumables are expired or otherwise unusable, and pharmacy 112 will then generate a primary expiration transaction, and the relevant portion of expired/unusable consumables are delivered to shipping facility 118 for appropriate resolution. Relevant details of the primary expiration transaction are then submitted to blockchain 102 for validation and appending thereto.

Referring back to the receipt of consumables by storage facility 114 in step S128, upon validation of the departmental redistribution transaction thereof, storage facility 114 makes a determination that the received consumables are: (i) subject to internal redistribution within storage facility 114; (ii) subject to secondary departmental redistribution to pharmacy 112; (iii) designated for immediate consumption by patient 116; or (iv) expired, or otherwise unusable. Details of this determination are encoded into one of the following transactions, which is initiated based on the result of the determination. In this example, pharmacy 112 may represent a hospital with a central pharmacy, and storage facility 114 may represent one or more departmental pharmacies and/or ward lockboxes of the hospital, and the received consumables will typically be stored under secure conditions by trusted parties.

If storage facility 114 determines that the received consumables (or a portion thereof) are subject to internal redistribution, system 100 initiates step S134, in which an internal redistribution transaction is generated, and the received consumables are redistributed within storage facility 114. In some embodiments of step S134, the internal redistribution transaction represents a physical relocation of all or part of the stored consumable, e.g., from one lockbox to another. In other embodiments of step S134, the internal redistribution transaction may represent only an update of the status of the consumable in storage facility 114, such as from an inventory check, where the physical location of the consumable may not change, but encoded details of the inventory check may reflect a new time, date, and/or trusted party, etc. In all such instances, details of the internal redistribution transaction are submitted to blockchain 102, as a single transaction or as multiple sub-transactions, for validation and addition to the ledger.

In the exemplary embodiment, the internal redistribution transaction of step S134 will encode the same ID for both the deliverer and the recipient of the consumables. In some embodiments though, the internal redistribution transaction may include different IDs for other encoded details such as, for example, where the idea of a trusted party that receives the consumables at storage facility 114 may be different from the idea of a different trusted party who performs a subsequent inventory, or internal physical transfer, of the same consumable. In the case where the consumable is data, the internal redistribution transaction of step S134 may be, for example, submitted to blockchain 102 for each instance where a data file is moved (within the same data storage subsystem), renamed, opened, viewed, or otherwise accessed. According to step S134, such internal department distribution transactions allow for tracking of materials transferred between various locations, as well as between various trusted parties, of a single facility. In the embodiments described herein, the recorded transaction encodes an amount of the consumables that is returned to a particular storage areas, or even original storage area, in the case when, for example, an entire quantity of the consumable may have to be removed from storage to measure and count only a portion thereof for delivery (e.g., a pharmacist removing a larger container of a pharmaceutical to dose a limited quantity thereof to a patient, and then returning the larger container having the unused portion of the pharmaceutical to the same storage location).

If storage facility 114 alternatively determines, after validation of step S128, are subject to redistribution or return to pharmacy 112, storage facility 114 of system 100 initiates step S136, in which a secondary departmental redistribution transaction is generated, and the received consumables are delivered from storage facility 114 back to pharmacy 112. In step as 136, the secondary departmental redistribution transaction further encodes, similar to the transactions described above, details regarding the quantity of consumables returned to pharmacy 112. All such details are submitted to blockchain 102 as a single transaction or multiple sub-transactions for validation and addition to the ledger.

In another alternative, if storage facility 114 determines that some or all of the received consumables are designated for immediate consumption by patient 116 (or multiple patients 116), step S138 is initiated, in which a secondary prescription transaction is generated, and all or some of the consumables received by storage facility 114 are delivered to patient 116 in a manner similar to the primary prescription transaction and delivery in step S130, including potential delivery to a plurality of patients 116. The details of the secondary prescription transaction(s) are then submitted to blockchain 102 in a similar manner as are the details of the primary prescription transaction. In other words, when a stored consumable is directly consumed from storage, a transaction (the secondary prescription transaction in this example) is generated between the storage ID and consumer ID, and undelivered portions of the consumables, or other changes to the condition/status of the remaining consumables are noted/encoded in a subsequent transaction.

Referring back to the determination made by storage facility 114 after validation of step S128, in some instances, the determination is made that all or some of the received consumables are expired or otherwise unusable, and storage facility 114 will then generate a secondary expiration transaction, and the relevant portion of expired/unusable consumables are delivered to shipping facility 118 for appropriate resolution. Relevant details of the secondary expiration transaction are then submitted to blockchain 102 for validation and appending thereto.

Referring back to the receipt of consumables by patient 116 after validation of step S130, in some instances, some or all of the received consumables may not be used, and subject to return to pharmacy 112 (e.g., in the case of controlled substance pharmaceuticals). Upon such determination, in step S142, patient 116 returns the unused consumable to pharmacy 112, and an unused consumable transaction is generated by system 100—typically by pharmacy 112—and relevant details of the unused consumable transaction are submitted to blockchain 102 for validation and appending thereto.

And storage facility 114 will then generate a secondary expiration transaction, and the relevant portion of expired/unusable consumables are delivered to shipping facility 118 for appropriate resolution. Relevant details of the secondary expiration transaction are then submitted to blockchain 102 for validation and appending thereto.

Upon validation of one of steps S126, S132, or S140, confirming the receipt of a consumable at shipping facility 118, in step S144, shipping facility 118 generates a disposal transaction to initiate delivery of the received consumable to resolution state 120. In some embodiments, resolution state 120 represents a separate and secure disposal facility for verifiably disposing of the received consumable, and according to local, state, federal, and/or international regulations where applicable. In other embodiments, shipping facility 118 includes an internal facility or capability to dispose of the received consumable in, or transition the received consumable to, resolution state 120. In the exemplary embodiment, the disposal transaction performed in step S144 is submitted to blockchain 102 as a destruct transaction, which, upon validation and addition to the ledger, renders further transactions (i.e., for the relevant portion of consumables received by shipping facility 118) on blockchain 102 impossible.

Nevertheless, the transition to resolution state 120 does not remove transactions, sub-transactions, details, or other entries from blockchain 102, even after physical destruction of the respective consumable at shipping facility 118 (or in the case of data consumables, deletion thereof). The disposal/destruct transaction is itself subject to validation and recordation on blockchain 102, and serves as a final transaction entry on the ledger that designates particular details of the ledger that are appropriate to permanently retain regarding the lifecycle of the consumable (or the relevant portion thereof) from genesis to resolution state 120. Accordingly, upon validation and recording of the disposal transaction, blockchain 102 renders that portion of the consumable from the original genesis transaction unavailable for further consumption, even if the consumable is not physically destroyed. That is, blockchain 102 verifies that any portion of an original shipment that has transitioned to resolution state 120 is unavailable or further traversal of system 100, or elsewhere.

In a similar manner, referring back to the receipt of consumables as a primary prescription transaction in step S130, or as a secondary prescription transaction in step S138, upon validation of the receipt of the consumable by patient 116, in step S146, system 100 will generate a consumption transaction that indicates a transition of the relevant quantity of the received consumable to resolution state 120. In the example of a medical patient, physical consumption of a pharmaceutical will, for example, result in a final disposition of the consumable pharmaceutical. The case where patient 116 is within a hospital facility, the consumption transaction may, for example, be generated as a result of a trusted party (e.g., a doctor, nurse, etc.) or a trusted device (e.g., a drug delivery machine) attesting to the actual consumption of the pharmaceutical by patient 116. In the case where a patient receives a pharmaceutical consumable to be consumed over time (e.g., a 30-day period), the consumption transaction may, for example, be generated after the relevant time period (e.g., 30 days) has elapsed. The validation of the consumption transaction from step S146 will, similar to the disposal transaction of step S144, verify that the relevant portion of the original shipment is unavailable for further use or traversal.

Referring back to receiver 110, in some embodiments, receiver 110 further includes its own receiver storage facility (not shown), in which all or some of the original shipment received in step S122 may be temporarily stored after generation of the initial entry transaction of step S124, but prior to delivery of the original shipment, or portions thereof, to distributor/pharmacy 112. In this example, transfers to the receiver storage facility (or facilities) from receiver 110 are similar to those described above with respect to transfers from pharmacy 112 to storage facility 114, and may generate their own sub-transactions for submission, validation, and recording utilizing blockchain 102.

In some embodiments, system 100 is further configured to, upon transition of a consumable to resolution state 120 (e.g., after validation by blockchain 102 of step S144 or step S146), transmit a notification or alert to a relevant party 104 to refill, reorder, or replace the expired consumable. In the case of prescription pharmaceuticals, the notification/alert may be an electronic notification to pharmacy 112 or patient 116 to refill the prescription. In at least one embodiment, notification/alert will automatically refill the prescription upon transition to resolution state 120, e.g., after an elapse of the appropriate time period.

In at least one embodiment, system 100 is further configured to monitor each of the transaction and sub-transactions recorded on blockchain 102. Such monitoring may be periodic, or initiated upon a change of status or division of the consumable. In this embodiment, system 100 may be further configured to transmit a notification or alert to one or more of the respective parties 104 upon detection of an unauthorized change in the status/details of the respective consumable being monitored.

As described above, the embodiments herein implement distributed ledger technology, and are not limited solely to blockchains. A blockchain is theoretically perpetual, however, at a fundamental level, the notion that a particular blockchain is eternally viable (or even viable for many decades or longer) may not be a reasonable assumption, even as technology continues to improve. Furthermore, it is an unlikely expectation that all transactions within a blockchain will be able to stand on a queue or list indefinitely. Accordingly, it is contemplated herein that the systems and methods the present embodiments may further implement recovery and/or damage containment mechanisms to mitigate the effects of corruption of a monolithic blockchain or of a blockchain forest.

In the exemplary embodiments described above, blockchain 102 may implement a registration model, which may advantageously achieve centralization and provide further stability and predictability to a blockchain ecosystem. Alternatively, blockchain 102 may implement a consensus model to advantageously provide additional security to the blockchain ecosystem. In a consensus model alternative, for example, particular participant roles within the distributed ledger network may be integrated in multiple processors capable of negotiating participation and fulfillment operations collectively, utilizing either another blockchain (e.g., a management blockchain), or a consensus driven database (such as Cassandra).

In some embodiments, the security of new blockchains may be improved by including a blockchain hash from another chain, either from within a blockchain forest, or from an independent blockchain (such as Bitcoin). This separate hash may be included as part of the archival process, or may be included prior to archival from within the lifecycle of the blockchain. Accordingly, milestones of one blockchain may then be communicated and distributed to other blockchains as transactions. These new transactions can be performed at defined time intervals, at defined block heights (e.g., as part of instantiation and/or user request requirements), or associated with other activity within a blockchain forest (e.g., when another blockchain is instantiated or destroyed). An additional blockchain forest mechanism may serve to advantageously create a lattice of blockchains that is more secure than conventional monolithic implementations because adversaries of the blockchain are now required to attack multiple blockchains to perform a history attack, for example.

As described above, system 100 advantageously realizes the ability to create blockchains as necessary (e.g., the Genesis transaction), and terminate such blockchains (e.g., resolution state 120) in a straightforward manner when they are no longer needed. In contrast, conventional monolithic blockchains have been known to grow in an unbounded manner. After years of operation, the height of such conventional blockchains, their number of unspent transactions, their network performance of the consensus pool, etc. have been seen to grow to the point that the blockchain does not perform well. Other blockchains may be less successful, and have a small number of participants. Where blockchains operate collectively, systems and methods according to the present embodiments may further advantageously realize the ability to terminate corrupted blockchains that are no longer useful, while improving the security of blockchains having a smaller number of participants.

Irrespective of the particular architecture/methodology of the blockchain, or of the distributed ledger, systems and methods according to the present embodiments realize still further advantages over conventional consumable tracking systems and techniques. In one example, where federal regulations exist that prevent unused controlled substances from being recycled, redistributed, or otherwise reused, a black market nevertheless exists for selling such controlled substances that should have been destroyed. Through the advantageous techniques of the present embodiments, disposition of the status of a particular consumable is easier to transparently and verifiably monitor, and appropriate parties may be given a timely alert upon the unauthorized transfer (e.g., theft) of a controlled substance, or an attempt to redistribute a controlled substance that is intended for destruction.

Even in cases where regulations lawfully allow the reuse of unused consumables, embodiments according to the present systems and methods have still further advantage that new potential consumers of the redistributed consumables may more reliably verify the history of the consumable, and also whether the correct handling procedures (e.g., encoded in respective transactions recorded on blockchain 102) have been followed before the consumable may reenter circulation.

Furthermore, the present embodiments are similarly useful regarding consumables in other fields, such as with regard to weapons (e.g., firearms) that are often subject to destruction orders, but are sometimes found back in circulation after the weapon is reported as being destroyed. In such instances, the weapon itself may include its own ID that is encoded with the relevant transactions, and the present systems and methods thus provide a more reliable record to be consulted to track the status of the weapon such that an accurate chain-of-title may be established therefor. In the case where the weapon is intended for physical destruction, the present systems and methods advantageously allow for easier identification of the weapon, and the identity of the trusted party responsible for its destruction, if the weapon reappears on the black market in contravention of the law.

According to the embodiments described above, the present systems and methods may also be advantageously implemented with respect to hyper ledgers, which represent a cross-industry collaboration to develop blockchains and/or distributed ledgers having improved performance and reliability capable of supporting global business transactions by major technological, financial, and supply chain companies. Hyperledgers integrate independent open protocols and standards through a framework of use-specific modules, including blockchains having their own consensus and storage routines, in addition to service modules for identity, access control, and smart contracts.

The systems and methods described herein therefore allow for the ability to more securely encode the consumptions of materials or data, and track and execute the encoded transactions in immutable distributed ledgers that are more reliable than conventional systems, while also providing greater transparency. The details of the materials, data, or other consumables, including the condition or configuration thereof, may be asserted through secure off-chain interfaces, or alternatively may be encoded directly into each transaction submitted to the digital ledger. The present systems and methods, by cryptographically protecting transactions and recording the cryptographically protected transactions on blockchain, may operate as a stand-alone system, or may advantageously complement conventional material management processes and tracking techniques. Different from conventional systems, the present embodiments assure that persons responsible for physical material management steps, or virtual data entry, are trusted parties that physically or virtually execute the relevant associations, deliveries, and other status changes of the tracking system. Each such trusted party will therefore have its own secure ID (e.g., public and private keys, or equivalent token mechanism) which is included in each relevant transaction that results in a change of status of the respective consumable goods.

### Supply Chain, Transmitted/Stored Information Protection

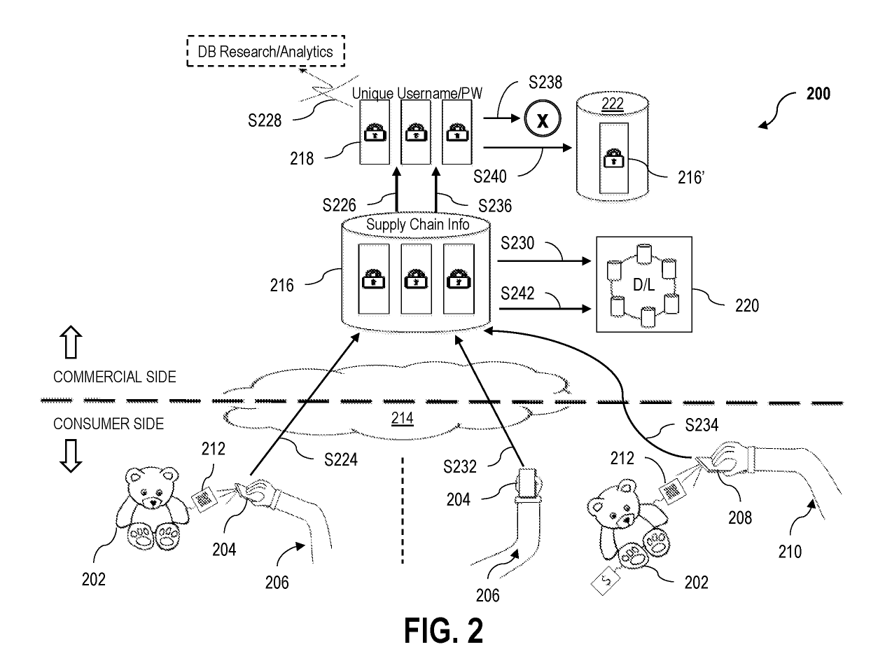

FIG. 2 is a schematic flow illustration of a supply chain tracking process 200. In an exemplary embodiment, tracking process may use one or more of the supply chain components and steps of system 100, FIG. 1. In this example, the goods in question may be more properly labeled as “reusable,” as opposed to “consumable.” Nevertheless, for some types of goods within the scope of this application, the two terms are somewhat interchangeable.

In the exemplary embodiment, process 200 may be executed to track a consumable or reusable interactive good 202 with respect to a first consumer device 204 of a first consumer 206 and a second consumer device 208 of a second consumer 210. Interactive good 202 may, for example, include at least one identifier 212 (e.g., a QR code, a barcode, a device ID in alphanumeric form, etc.). In some embodiments, process 200 is performed, at least in part, over an electronic network 214 (e.g., the Internet, Cloud, LAN, WAN, WLAN, etc.), which may incorporate wired or wireless technology, or a combination thereof.

Process 200 is further performed in operable communication with a supply chain storage system 216. In the exemplary embodiment, storage system 216 is configured to generate or store one or more encrypted device data files 218. Storage system 216 may be in operable communication with electronic network 214, and also with a distributed ledger 220 (e.g., digital ledger, blockchain, etc.). In some embodiments, process 200 further implements a secondary storage 222.

In exemplary operation, process 200 begins at step S224, in which interactive good 202 is purchased, that is, “consumed,” by first consumer 206. In an exemplary embodiment of step S224, first consumer 206 uses first consumer device 204 to enter identifier 212 (e.g., by manually entering an alphanumeric code, by scanning a QR code with a camera of device 204 such as a smart phone) and transmit the entered identifier 212 to storage system 216 over electronic network 214. In at least one embodiment of step 4 transmission of identifier 212 may be performed directly between first consumer device 204 and storage system 216.

In one example of step S224, first consumer 206 is a consumer who, at the time of purchase of interactive good 202, the consumer scans a unique manufacturer QR code (e.g., identifier 212) attached to the interactive device (e.g., good 202) with the consumer's phone (e.g., first consumer device 204). Transmission of the QR code (or other identifier), in this example, enables storage system 216 (or any third party server associated therewith) to provide the consumer with a webpage in which the consumer may then set up a username/password, along with an associated email protected account, on storage system 216 or the third party server, as described further below with respect to step S226.

In step S226, storage system 216 interacts with first consumer device 204 to enable first consumer 206 to establish unique personal control (e.g., a unique username and password combination, etc.) over some or all data transmitted from first consumer device 202 to storage system 216. In an exemplary embodiment of step S226, interaction between consumer device 204 and storage system 216 is a sequential. For example, storage system may send a request or notice to first consumer device 204 upon receiving transmitted identifier 212. In other embodiments, first consumer device 204 may transmit at least some information about first consumer 206 along with transmitted identifier 212. In the exemplary embodiment, upon establishment of personal control, storage system 216 stores the received consumer data, along with transmitted identifier 212, in one or more encrypted data files 218. Encrypted data files 218 may, for example, utilize PKI techniques, as described above.

Further to the example described above, if the purchased device (e.g., interactive good 202) is an interactive toy, the set-up of the up of the account may be further configured to incorporate legally necessary parental permissions. The QR code/identifier 212 may then serve as a basis for a shared secret with which all communications between first consumer device 204 and the consumer file (e.g., encrypted data file(s) 218) may be subsequently encrypted. In some embodiments, the QR code (e.g., identifier 212) may be further configured to provide information to the manufacturer, storage system 216, or a third party to alert the relevant entity that the device has been sold/consumed. In at least one embodiment, geo-tagging information (e.g., from a GPS-equipped phone) is transmitted with identifier 2122 indicate the geographic location of the sale/consumption. This information may then be added to the manufacturer's supply chain information (including, but not requiring a block chain) to track both initial sales of interactive good 202, as well as subsequent sales, consumptions, or uses of good 202.

Step S228 is optional. In step S228, storage system 216 is configured to make available some of the stored consumer data to a database research or analytics entity, based on the respective privacy policy of storage system 216. In an exemplary embodiment of step S228, the available consumer data is anonymized before being made available to the research/analytics entity, such that no personal identifying information is exposed to an outside party.

In step S230, storage system 216 is configured to confirm “consumption” of interactive good 202, and updates digital ledger 220 with information regarding the relevant transaction(s) performed. In the exemplary embodiment of step S228, only the transaction information is used to update digital ledger 220, and not personally identifying information about first consumer 206.

In further exemplary operation of process 200, after the passage of some time from the initial consumption of good 202 by first consumer 206, in step S232, physical possession and/or ownership of good 202 passes from first consumer 206 to second consumer 210 (e.g., from a private resale, gifting, loan, etc.). In an exemplary embodiment of step S232, upon the sale of interactive good/device 202 to second consumer 210, first consumer 206 communicates with storage system 216 to instruct storage system 216 to delete or store the consumer data of first consumer 206 that is stored within encrypted file/protected account 218.

In step S234, second consumer 210 is enabled to enter identifier 212 into a transmission sent to storage system 216 (e.g., scans the QR code with second consumer device 208, which allows set-up of a new account for consumer 210 to access the interactive functionality of interactive good 202). In an exemplary embodiment, steps S232 and S234 may be performed independently of one another. For example, account set-up by second consumer 210 in step S234 may not be dependent on first consumer 206 deleting the first protected account. In another example, step S234 might be enabled only after the execution of step S232 by first consumer 206, in order to avoid potential theft and/or unauthorized use of good 202 by unauthorized consumer. In some cases, step S234 may be configured such that an alert (e.g., text message, email, etc.) is sent to first consumer 206 to allow first consumer 206 the opportunity to confirm the transfer of possession of good 202. That is, in the event that first consumer 206 did not delete the data (or otherwise instructed as to termination of possession), transmission of identifier 212 by second consumer 210 (e.g., by scanning the QR code of device 202), step S234 may be configured to automatically alert first consumer 206 of the need to delete the relevant account information.

In an alternative embodiment, step S234 represents a case of a replacement device, that is, first consumer 206 and second consumer 210 are the same, and original device 202 is substituted with a replacement device 202′. In this case, step S234 may be configured such that first consumer 206 is able to direct storage system 216 to move relevant data from protected account/encrypted data file 218 to a new, or updated, data file 218′ that corresponds to the replacement device 202′instead of the original device 202.

In step S236, storage system 216 is configured to interact with second consumer device 206 to enable establishment of a new protected account for second consumer 210, which is stored within storage system 216 as a unique encrypted data file 218′. Accordingly, when second consumer 210 sets up his/her own new unique account, the relevant supply chain information is updated with the new consumer purchase information, and in a secure manner that allows ongoing tracking of device 202, but separately from identifying information of the respective consumers as ownership or possession of the interactive device changes. Some or all of the steps of process 200 may therefore be repeated indefinitely until the device 202 is no longer is sold to a new consumer, or in the case where storage system 216 is notified that device 202 is expired, unusable, or destroyed, as described above with respect to system 100, FIG. 1.

In step S238, storage system 216 deletes encrypted data file 218 of first consumer 206, according to instructions from first consumer 206, or according to the particular data security and retention policy of storage system 216. Alternatively to step S238, storage system 216 may, in step S240, move the data from the first encrypted data file 218 into secondary storage 222 for long term retention. Similar to alternative step S238, step S240 may also be performed as a result of instructions from first consumer 206, or may be based upon the security and/or retention policies of storage system 216. In step S242, digital ledger 220 is updated with the relevant transaction information regarding the transfer of good/device 202 from first consumer 206 to second consumer 210.

Accordingly, the innovative systems and methods described herein are of particular value within the realm of consumable goods that are interactive devices (e.g., Internet-connected toys, baby monitors, IoT devices, etc.), which have been historically associated with a poor record of securing customer communications and data. The present embodiments enable more reliable tracking of such devices, but without compromising consumer data and communications. Furthermore, according to the disclosed techniques, interactive device providers are better able to track the life of a device post-sale, and thereby more easily notify consumers of recalls of the device, which may be a significant issue particularly in the realm of interactive devices for infants and small children. Moreover, the ability to more reliably track devices, but without adding additional risk to consumer data, greatly enhances the ability of manufacturers to realize secondary market revenue for a device, such as in the case of software updates to the device programming, or new commercial opportunities that may be exploited in association with the device (e.g., marketing promotions, cross-sales, seasonal activities).

Exemplary embodiments of systems and methods for securing consumer data for trackable consumer goods are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for monitoring the status of a consumable good transferred from a first consumer to a second consumer, comprising:
a first consumer device capable of acquiring an identifier from the consumable good;
a storage subsystem configured to store one or more encrypted data files;
an electronic network configured to transmit the acquired identifier from the first consumer device to the storage subsystem; and
a second consumer device capable of acquiring the identifier from the consumable good and transmitting the acquired identifier to the storage subsystem
wherein the storage subsystem is further configured to store the acquired identifier from the first consumer device in a first encrypted data file, and
wherein the storage subsystem is further configured to (i) store the acquired identifier from the second consumer device in a second encrypted data file, and (ii) delete or move the first encrypted data file upon creation of the second encrypted data file.
